(19) United States
(12) Patent Application Publication
(10) Pub. No.: US 2023/0408343 A1
(43) Pub. Date: Dec. 21, 2023

(54) SENSOR SYSTEMS AND METHODS FOR HVAC SYSTEMS

(71) Applicant: Air Distribution Technologies IP, LLC, Milwaukee, WI (US)

(72) Inventor: Shaun B. Atchison, Wichita, KS (US)

(21) Appl. No.: 17/808,064

(22) Filed: Jun. 21, 2022

(51) Int. Cl. G01K 1/10; G01K 1/14; F24F 11/89; F24F 11/88

(52) U.S. Cl. CPC G01K 1/10; G01K 1/14; F24F 11/89; F24F 11/88; F24F 2110/10

(57) ABSTRACT

A sensor assembly for a heating, ventilation, and air conditioning (HVAC) system includes a circuit board and a plurality of sensors disposed on the circuit board. The plurality of sensors is configured to detect one or more properties of an air flow directed across the circuit board and each sensor of the plurality of sensors is individually encapsulated by a respective amount of an encapsulation material.

### BACKGROUND

This section is intended to introduce the reader to various aspects of art that may be related to the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, and/or air conditioning (HVAC) systems are utilized in residential, commercial, and industrial applications to control environmental properties, such as temperature and humidity, for occupants of respective environments. An HVAC system may control the environmental properties through control of properties of an air flow delivered to and ventilated from spaces serviced by the HVAC system. For example, the HVAC system may transfer heat between the air flow and refrigerant flowing through the system (e.g., a heat exchanger) to provide cooled air for an indoor environment. Similarly, the HVAC system may heat the air flow to provide warmth to an indoor environment. In some situations, the HVAC system may cool the air flow and then heat the air flow to reduce humidity of the air flow while providing air at a desired temperature to the indoor environment. The HVAC system may also control a flow rate of the air flow to manage (e.g., expedite transitioning between) environmental conditions.

Operation of HVAC systems may be controlled based at least in part on feedback indicative of operating conditions detected by one or more sensors. Sensor assemblies disposed within HVAC systems may utilize sensors (e.g., thermistors, electronic measuring components) on a circuit board to capture and record properties (e.g., temperature, air flow, humidity) of one or more fluid flows directed through and/or conditioned by the HVAC system. During operation, the sensors may be exposed to various environmental conditions via the one or more fluid flows that may cause degradation to the sensors which may affect the performance capabilities of the circuit board. For instance, during operation, the thermistors may attract certain ions and other environmental elements (e.g., dust, debris, salt, humidity), which may cause oxidation to the electrical connections between the sensors and the circuit board, thereby limiting the sensor's performance (e.g., ability to communicate data associated with the fluid flow directed across the sensor). Accordingly, it now recognized that improved systems and methods for protecting sensors on a circuit board from environmental conditions are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a sensor assembly for a heating, ventilation, and air conditioning (HVAC) system includes a circuit board and a plurality of sensors disposed on the circuit board. The plurality of sensors is configured to detect one or more properties of an air flow directed across the circuit board and each sensor of the plurality of sensors is individually encapsulated by a respective amount of an encapsulation material.

In another embodiment, a circuit board for a sensor assembly of a heating, ventilation, and air conditioning (HVAC) system includes a plurality of layers, a first sensor, and a second sensor. The first sensor is externally disposed on the plurality of layers and is encapsulated by a first amount of an encapsulation material. The second sensor is encapsulated by a second amount of the encapsulation material. The first amount of the encapsulation material is separate from the second amount of the encapsulation material.

In another embodiment, a method of producing a circuit board having a plurality of sensors includes applying a first amount of an encapsulation material to a first sensor of the plurality of sensors to encapsulate the first sensor on the circuit board. The method further includes separately applying a second amount of the encapsulation material to a second sensor of the plurality of sensors to separately encapsulate the second sensor on the circuit board. The method further includes curing the first amount of the encapsulation material and the second amount of the encapsulation material to adhere the first amount and the second amount to the circuit board.

### BRIEF DESCRIPTION OF THE DRAWINGS

Various aspects of the present disclosure may be better understood upon reading the following detailed description and upon reference to the drawings, in which:

FIG. 1 is a perspective view of an embodiment of a building including a heating, ventilation, and air conditioning (HVAC) system, in accordance with an aspect of the present disclosure;

FIG. 2 is a block diagram of an embodiment of an airside system of an HVAC system, including an air handing unit (AHU), in accordance with an aspect of the present disclosure;

FIG. 3 is a perspective view of an embodiment of a sensor assembly, in accordance with an aspect of the present disclosure;

FIG. 4A is a top view of an embodiment of a circuit board, in accordance with an aspect of the present disclosure;

FIG. 4B is a side view of an embodiment of the circuit board of FIG. 4A, in accordance with an aspect of the present disclosure;

FIG. 5A is a top view of an embodiment of a circuit board, in accordance with an aspect of the present disclosure;

FIG. 5B is a bottom view of an embodiment of the circuit board of FIG. 5A, in accordance with an aspect of the present disclosure;

FIG. 5C is a side view of an embodiment of the circuit board of FIG. 5A, in accordance with an aspect of the present disclosure;

FIG. 6 is a side view of an embodiment of a circuit board illustrating one or more fluid flows directed over the circuit board, in accordance with an aspect of the present disclosure;

FIG. 7 is a schematic of an embodiment of an encapsulation material application system, in accordance with an aspect of the present disclosure; and

FIG. 8 is an embodiment of a flow chart of a method for encapsulating one or more sensors on a circuit board, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

It is now recognized that traditional HVAC systems employing circuit boards or other substrates having one or more sensors (e.g., thermistors) may not adequately protect sensory components (e.g., sensors, electrical connections associated with the sensors) from wear and degradation resulting from exposure to environmental elements (e.g., outside environmental elements, humidity, salt water, sulfur, dust, debris) that may be present during operation of HVAC systems. For example, traditional (e.g., existing) coating methods may apply (e.g., spray) a coating material to an entire circuit board to protect electrical components from wear and degradation. However, due to the low viscosity of traditional coating materials, as the circuit board undergoes a curing process, the coating material applied to the electrical components may migrate from an intended location on a circuit board to a different location of the circuit board, thereby leaving one or more of the electrical components (e.g., sensors, thermistors) exposed to environmental conditions or elements that may adversely affect operation of the electrical components and/or circuit board. Thus, it is now recognized that improved systems and methods for protecting sensory components (e.g., thermistors) disposed within an HVAC system are desired.

Accordingly, the present disclosure is directed to an improved system and method for protecting, such as via encapsulation, one or more sensors (e.g., thermistors) configured to detect (e.g., measure) properties (e.g., temperature, humidity, flow rate, flow volume) of one or more fluid flows (e.g., air flow, working fluid flow) directed through the HVAC system. For example, the present techniques discussed herein include applying a material (e.g., protective material, encapsulation material) to one or more sensors disposed on a circuit board or other support structure. The applied material may have a high viscosity that maintains (e.g., substantially maintains) a desired form factor (e.g., shape) before the applied material undergoes a curing process. The material may be applied in a controlled manner such that a dome-like structure or geometry is formed over a sensor disposed on a circuit board. In this way, present embodiments enable improved protection of sensors and/or the electrical connections associated with the sensors, thereby limiting an amount of exposure of the sensors to environmental elements. Further, by utilizing a material with a high viscosity and by applying the material to a targeted location on the circuit board, a dome-like structure with desired dimensions (e.g., height, diameter) may be formed to protect (e.g., encapsulate) the sensor. The dome-like structure may be configured to reduce an amount of interference with a fluid flow directed over the sensor and/or the circuit board on which the sensor is disposed. That is, by encapsulating the sensors in a dome-like structure, a fluid flow directed over the encapsulated sensor may flow across the circuit board with decreased resistance, thereby enabling more efficient flow of fluid across the circuit board and/or sensor.

In view of the foregoing, present embodiments, as compared to traditional HVAC systems employing existing coating systems and methods, may provide improved sensor systems that are resistant to environmental conditions or elements, thereby limiting an amount of wear and degradation to a sensor of the sensor systems. Further still, by limiting an amount of material (e.g., protective material, encapsulation material) applied to the sensor and/or support structure of the sensor (e.g., circuit board), an amount of material used to encapsulate the sensor may be reduced, thereby reducing costs and increasing efficiency associated with the manufacture of sensor assemblies of HVAC systems.

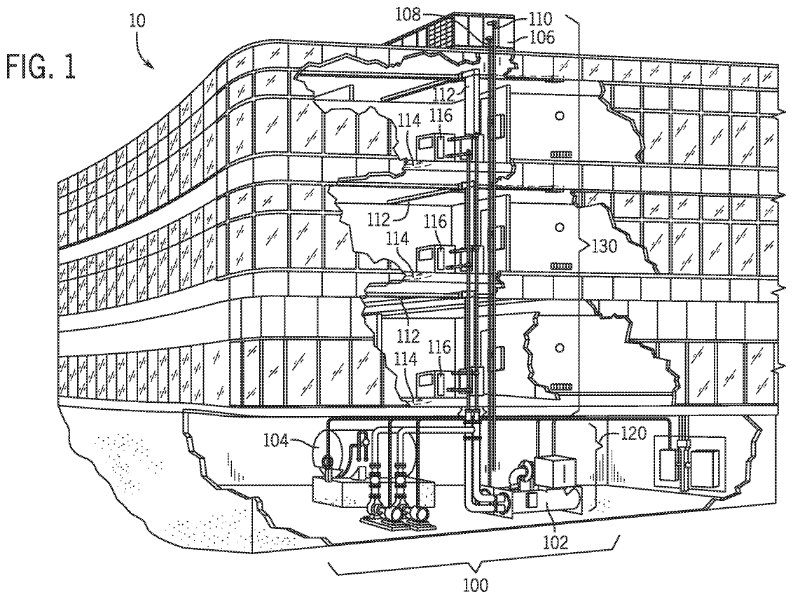

Turning now to the drawings, FIG. 1 illustrates a perspective view of a building 10. The building 10 is served by a heating, ventilating, or air conditioning (HVAC) system 100. The HVAC system 100 can include a plurality of HVAC devices or subsystems (e.g., heaters, chillers, air handling units, pumps, fans, thermal energy storage, etc.) configured to provide heating, cooling, air conditioning, ventilation, and/or other services for the building 10. For example, the HVAC system 100 is shown to include a waterside system 120 and an airside system 130. The waterside system 120 may provide a heated or chilled fluid to an air handling unit of the airside system 130. The airside system 130 may use the heated or chilled fluid to heat or cool an air flow provided to the building 10.

The HVAC system 100 is shown to include a chiller 102, a boiler 104, and a rooftop air handling unit (AHU) 106. The waterside system 120 may use the boiler 104 and the chiller 102 to heat or cool a working fluid (e.g., water, glycol, etc.) and may circulate the working fluid to the AHU 106. In various embodiments, the HVAC devices of the waterside system 120 can be located in or around the building 10 (as shown in FIG. 1) or at an offsite location such as a central plant (e.g., a chiller plant, a steam plant, a heat plant, etc.) that serves one or more buildings including the building 10. The working fluid can be heated in the boiler 104 or cooled in the chiller 102, depending on whether heating or cooling is required in the building 10. The boiler 104 may add heat to the circulated fluid, for example, by burning a combustible material (e.g., natural gas) or using an electric heating element. The chiller 102 may place the circulated fluid in a heat exchange relationship with another fluid (e.g., a refrigerant) in a heat exchanger (e.g., an evaporator) to absorb heat from the circulated fluid. The working fluid from the chiller 102 and/or the boiler 104 can be transported to the AHU 106 via piping 108.

The AHU 106 may place the working fluid in a heat exchange relationship with an air flow passing through the AHU 106 (e.g., via one or more stages of cooling coils and/or heating coils). The air flow can be, for example, outside air, return air from within the building 10, or a combination of both. The AHU 106 may transfer heat between the air flow and the working fluid to provide heating or cooling for the air flow. For example, the AHU 106 can include one or more fans or blowers configured to pass the air flow over or through a heat exchanger containing the working fluid. The working fluid may then return to the chiller 102 or the boiler 104 via piping 110.

The airside system 130 may deliver the air flow supplied by the AHU 106 (i.e., the supply air flow) to the building 10 via air supply ducts 112 and may provide return air from the building 10 to the AHU 106 via air return ducts 114. In some embodiments, the airside system 130 includes multiple variable air volume (VAV) units 116. For example, the airside system 130 is shown to include a separate VAV unit 116 on each floor or zone of the building 10. The VAV units 116 can include dampers or other flow control elements that can be operated to control an amount of the supply air flow provided to individual zones of the building 10. In other embodiments, the airside system 130 delivers the supply air flow into one or more zones of the building 10 (e.g., via the supply ducts 112) without using intermediate VAV units 116 or other flow control elements. The AHU 106 can include various sensors (e.g., temperature sensors, pressure sensors, etc.) configured to measure attributes of the supply air flow. The AHU 106 may receive input from sensors located within the AHU 106 and/or within the building zone and may adjust the flow rate, temperature, or other attributes of the supply air flow through the AHU 106 to achieve setpoint conditions for the building zone.

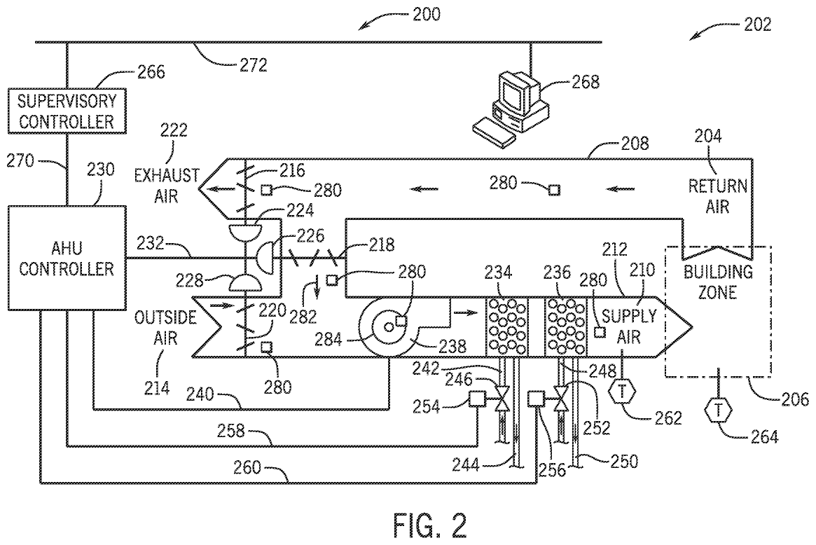

Referring now to FIG. 2, a block diagram of an airside system 200 is shown, according to some embodiments. In various embodiments, the airside system 200 may supplement or replace the airside system 130 in the HVAC system 100 or can be implemented separate from the HVAC system 100. When implemented in the HVAC system 100, the airside system 200 can include a subset of the HVAC devices in the HVAC system 100 (e.g., the AHU 106, the VAV units 116, the ducts 112-114, fans, dampers, etc.) and can be located in or around the building 10. The airside system 200 may operate to heat or cool an air flow provided to the building 10 using a heated or chilled fluid provided by the waterside system 120.

In FIG. 2, the airside system 200 is shown to include an economizer-type air handling unit (AHU) 202. Economizer-type AHUs vary the amount of outside air and return air used by the AHU 202 for heating or cooling. For example, the AHU 202 may receive return air 204 from building zone 206 via return air duct 208 and may deliver supply air 210 to building zone 206 via supply air duct 212. In some embodiments, the AHU 202 is a rooftop unit located on the roof of the building 10 (e.g., the AHU 106 as shown in FIG. 1) or otherwise positioned to receive both the return air 204 and outside air 214. The AHU 202 can be configured to operate an exhaust air damper 216, a mixing damper 218, and an outside air damper 220 to control an amount of the outside air 214 and the return air 204 that combine to form the supply air 210. Any return air 204 that does not pass through the mixing damper 218 can be exhausted from the AHU 202 through the exhaust damper 216 as exhaust air 222.

Each of the dampers 216-220 can be operated by an actuator. For example, the exhaust air damper 216 can be operated by an actuator 224, the mixing damper 218 can be operated by an actuator 226, and the outside air damper 220 can be operated by an actuator 228. The actuators 224-228 may communicate with an AHU controller 230 via a communications link 232. The actuators 224-228 may receive control signals from the AHU controller 230 and may provide feedback signals to the AHU controller 230. Feedback signals can include, for example, an indication of a current actuator or damper position, an amount of torque or force exerted by the actuator, diagnostic information (e.g., results of diagnostic tests performed by the actuators 224-228), status information, commissioning information, configuration settings, calibration data, and/or other types of information or data that can be collected, stored, or used by the actuators 224-228. The AHU controller 230 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control the actuators 224-228.

Still referring to FIG. 2, the AHU 202 is shown to include a cooling coil 234, a heating coil 236, and a fan 238 positioned within the supply air duct 212. The fan 238 can be configured to force the supply air 210 through the cooling coil 234 and/or the heating coil 236 and provide the supply air 210 to the building zone 206. The AHU controller 230 may communicate with the fan 238 via a communications link 240 to control a flow rate of the supply air 210. In some embodiments, the AHU controller 230 controls an amount of heating or cooling applied to the supply air 210 by modulating a speed of the fan 238.

The cooling coil 234 may receive a chilled fluid from the waterside system 120 via piping 242 and may return the chilled fluid to the waterside system 120 via piping 244. A valve 246 can be positioned along the piping 242 or the piping 244 to control a flow rate of the chilled fluid through the cooling coil 234. In some embodiments, the cooling coil 234 includes multiple stages of cooling coils that can be independently activated and deactivated (e.g., by the AHU controller 230, by a supervisory controller 266, etc.) to modulate an amount of cooling applied to the supply air 210.

The heating coil 236 may receive a heated fluid from the waterside system 120 via piping 248 and may return the heated fluid to the waterside system 120 via piping 250. A valve 252 can be positioned along the piping 248 or the piping 250 to control a flow rate of the heated fluid through the heating coil 236. In some embodiments, the heating coil 236 includes multiple stages of heating coils that can be independently activated and deactivated (e.g., by the AHU controller 230, by the supervisory controller 266, etc.) to modulate an amount of heating applied to the supply air 210.

Each of the valves 246 and 252 can be controlled by an actuator. For example, the valve 246 can be controlled by an actuator 254, and the valve 252 can be controlled by an actuator 256. The actuators 254, 256 may communicate with the AHU controller 230 via communications links 258, 260. The actuators 254, 256 may receive control signals from the AHU controller 230 and may provide feedback signals to the AHU controller 230. In some embodiments, the AHU controller 230 receives a measurement of the supply air temperature from a temperature sensor 262 positioned in the supply air duct 212 (e.g., downstream of the cooling coil 234 and/or the heating coil 236). The AHU controller 230 may also receive a measurement of the temperature of the building zone 206 from a temperature sensor 264 located in the building zone 206.

In some embodiments, the AHU controller 230 operates the valves 246 and 252 via the actuators 254, 256 to modulate an amount of heating or cooling provided to the supply air 210 (e.g., to achieve a setpoint temperature for the supply air 210 or to maintain the temperature of the supply air 210 within a setpoint temperature range). The positions of the valves 246 and 252 affect the amount of heating or cooling provided to the supply air 210 by the cooling coil 234 or the heating coil 236 and may correlate with the amount of energy consumed to achieve a desired supply air temperature. The AHU controller 230 may control the temperature of the supply air 210 and/or the building zone 206 by activating or deactivating the coils 234, 236, adjusting a speed of the fan 238, or a combination of both.

Still referring to FIG. 2, the airside system 200 is shown to include the supervisory controller 266 and a client device 268. The supervisory controller 266 can include one or more computer systems (e.g., servers, supervisory controllers, subsystem controllers, etc.) that serve as system level controllers, application or data servers, head nodes, or master controllers for the airside system 200, the waterside system 120, the HVAC system 100, and/or other controllable systems that serve the building 10. The supervisory controller 266 may communicate with multiple downstream building systems or subsystems (e.g., the HVAC system 100, a security system, a lighting system, the waterside system 120, etc.) via a communications link 270 according to like or disparate protocols (e.g., LON, BACnet, etc.). In various embodiments, the AHU controller 230 and the supervisory controller 266 can be separate (as shown in FIG. 2) or integrated. In an integrated implementation, the AHU controller 230 can be a software module configured for execution by a processor of the supervisory controller 266.

In some embodiments, the AHU controller 230 receives information from the supervisory controller 266 (e.g., commands, setpoints, operating boundaries, etc.) and provides information to the supervisory controller 266 (e.g., temperature measurements, valve or actuator positions, operating statuses, diagnostics, etc.). For example, the AHU controller 230 may provide the supervisory controller 266 with temperature measurements from the temperature sensors 262-264, equipment on/off states, equipment operating capacities, and/or any other information that can be used by the supervisory controller 266 to monitor or control a variable state or condition within the building zone 206.

The client device 268 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the HVAC system 100, its subsystems, and/or devices. The client device 268 can be a computer workstation, a client terminal, a remote or local interface, or any other type of user interface device. The client device 268 can be a stationary terminal or a mobile device. For example, the client device 268 can be a desktop computer, a computer server with a user interface, a laptop computer, a tablet, a smartphone, a PDA, or any other type of mobile or non-mobile device. The client device 268 may communicate with supervisory controller 266 and/or the AHU controller 230 via a communications link 272.

In accordance with present embodiments, the AHU 202 and/or the HVAC system 100 may include one or more sensor assemblies 280 configured to detect one or more operating parameters of a fluid flow directed through the AHU 202 and/or the HVAC system 100. As described in further detail below, an embodiment of the sensor assembly 280 may include one or more sensors or sensing components (e.g., thermistors) configured to enable detection and/or measurement of an operation parameter of a fluid flow. For example, the sensor assembly 280 may include multiple thermistors configured to measure a flow rate (e.g., mass flow rate) of a fluid flow via thermal dispersion techniques. The sensors may be disposed on a substrate, such as a circuit board, and may be protected via a coating applied to the sensors. For example, each sensor disposed on the substrate may be encapsulated via a protective material applied to the sensor and/or substrate. As described in further detail below, the protective material may be applied in a manner that enables desired protection of the sensor and the substrate (e.g., electrical connections) from external elements, such as moisture, dust, other particles or elements, and so forth, while also enabling reduced restriction of fluid flow directed across the sensor assembly 280.

Sensor assemblies 280 may be positioned at any suitable location within the AHU 202 and/or the HVAC system 100 to measure properties of a fluid flow. In some embodiments, sensor assemblies 280 may be arranged within the AHU 202 to measure one or more properties of an air flow directed through the AHU 202. For example, one or more sensor assemblies 280 may be disposed within the return air duct 208 to detect a property of the return air 204, adjacent the exhaust damper 216 to detect a property of the exhaust air 222, adjacent the outside air damper 220 to detect a property of the outside air 214, adjacent the mixing damper 218 to detect a property of mixed air 282 (e.g., return air 204 and outside air 214) upstream of the cooling coil 234 and/or the heating coil 236, within the supply air duct 212 to detect a property of the return air 210, or any combination thereof. In some instances, an embodiment of the sensor assembly 280 may be disposed at or within an inlet 284 of the fan 238 to detect a property of air flow directed into the supply air duct 212. Indeed, it should be appreciated that embodiments of the sensor assembly 280 may be disposed in any suitable location of the AHU 202 and/or HVAC system 100 to detect properties of fluid flow, in accordance with the present techniques.

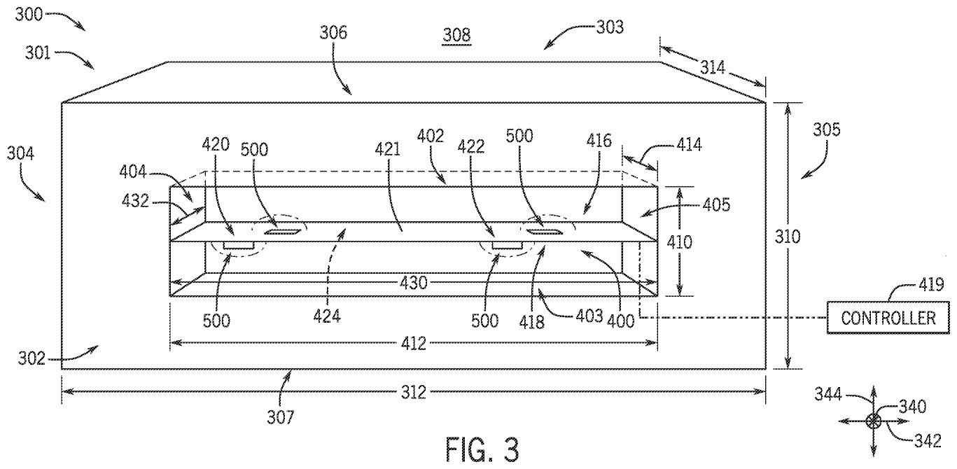

With this in mind, FIG. 3 is a perspective view of an embodiment of a sensor assembly 300 (e.g., sensing circuit, sensor assembly 280) that may be used with or in the systems of FIGS. 1 and 2 and/or in any other suitable HVAC system. For example, one or more sensor assemblies 300 may be disposed within a conduit (e.g., supply air duct 212, return air duct 208, plenum), fan inlet (e.g., inlet 284), fluid flow path (e.g., air flow path), or other suitable location within an HVAC system (e.g., the AHU 202). Each sensor assembly 300 may include one or more sensors (e.g., thermistors) configured to measure one or more properties (e.g., air velocity, temperature, humidity) of a fluid flow (e.g., airflow, refrigerant) directed across the sensor assembly 300. In some embodiments, the sensor assembly 300 may be configured to measure one or more properties of the fluid flow via implementation of thermal dispersion techniques. For example, a sensor of the sensor assembly 300 may include a first thermistor configured to detect a parameter (e.g., temperature) a fluid flow directed over the sensor and a second thermistor (e.g., heated thermistor) configured to apply heat to the fluid flow. The second thermistor may apply heat to the fluid flow to maintain a temperature differential (e.g., a target temperature differential) between the first thermistor and the second thermistor. As will be appreciated, fluid flow properties (e.g., flow rate, mass flow rate) of the fluid flow may be determined (e.g., via the sensor assembly 300, a controller) based on the temperature differential detected via the first and second thermistors and based on an amount of power supplied to the second thermistor to heat the fluid flow.

In some embodiments, the sensor assembly 300 may be disposed at or within a fan inlet (e.g., inlet 284) to measure properties of an air flow generated by a fan (e.g., fan 238) and directed through the fan inlet. The sensor assembly 300 may also be disposed within a duct or plenum configured to direct an air flow therethrough. In any case, the sensor assembly 300 may be configured to detect one or more properties of an air flow directed across the sensor assembly 300 disposed within a fan inlet or a duct. In the illustrated embodiment, the sensor assembly 300 includes a housing 301 (e.g., rectangular housing) defining an opening 400 extending through the housing 301 along a lateral axis 340 of the sensor assembly 300. In an installed configuration, the sensor assembly 300 may be disposed within a fluid flow path 308 (e.g., fan inlet, plenum, duct) such that the lateral axis 340 extends in a direction that is generally aligned with a direction of a fluid flow directed along the fluid flow path in which the sensor assembly 300 is disposed. A longitudinal axis 342 and a vertical axis 344 of the sensor assembly 300 may generally extend in respective directions crosswise to a direction of an air flow directed through the fluid flow path 308. The sensor assembly 300 and components thereof are described herein with reference to the lateral axis 340, longitudinal axis 342, and vertical axis 344 for clarity, but it should be appreciated that the sensor assembly 300 may be positioned, arranged, and/or installed within an air flow path in any desired orientation.

The housing 301 may include a first surface 302 (e.g., panel, front side, upstream side relative to a direction of air flow through the opening 400), a second surface 303 (e.g., panel, rear side, downstream side relative to a direction of air flow through the opening 400) opposite the first surface 302, a third surface 304 (e.g., panel, a first lateral side), a fourth surface 305 (e.g., panel, a second lateral side) opposite the third surface 304, a fifth surface 306 (e.g., panel, top side, upper side), and a sixth surface 307 (e.g., panel, bottom side, base) opposite the fifth surface 306. The housing 301 may extend a distance 310 (e.g., height) from the fifth surface 306 to the sixth surface 307 in a direction along the vertical axis 344 and may extend a distance 312 (e.g., length) from the third surface 304 to the fourth surface 305 in a direction along the longitudinal axis 342. Further, the housing 301 may extend a distance 314 (e.g., depth, width) from the first surface 302 to the second surface 303 in a direction along the lateral axis 340.

The first surface 302 and the second surface 303 may at least partially define the opening 400 extending through the housing 301. For example, the opening 400 may extend through the housing 301 along the depth 314 of the housing 301 from the first surface 302 to the second surface 303 and along the lateral axis 340. In other embodiments, the housing 301 may have another geometry, configuration, or shape, such as spherical, square, triangular, or any other suitable shape, and may include the opening 400 extending therethrough. As mentioned above, at least a portion of a fluid flow directed along the fluid flow path 308 may flow through the opening 400 of the housing 301. The sensor assembly 300 is configured to detect, measure, and/or collect data associated with the fluids flow (e.g., air flow) directed through the opening 400, as described in greater detail below.

As a fluid (e.g., air flow) is directed through the opening 400, one or more properties of the fluid (e.g., flow rate, flow volume, temperature, humidity, pressure) may be measured by one or more sensors 500 disposed within the opening 400 and exposed to the fluid flow directed through the opening 400. The opening 400 may be generally defined by one or more components of the housing 301. For example, in the illustrated embodiment, the opening 400 is generally defined by a first surface 402 (e.g., panel, top side, upper side), a second surface 403 (e.g., panel, bottom side) opposite the first surface 402, a third surface 404 (e.g., panel, first lateral side), and a fourth surface 405 (e.g., panel, second lateral side) opposite the third surface 404. The opening 400 may extend for a distance 410 (e.g., height) from the first surface 402 to the second surface 403 along the vertical axis 344, for a distance 412 (e.g., length) from the third surface 404 to the fourth surface 405 along the longitudinal axis 342, and for a distance 414 (e.g., depth, width) from the first surface 302 to the second surface 303 along the lateral axis 340. The height 410 and the width 412 of the opening 400 may be less than the height 310 and the width 312, respectively, of the housing 301. Thus, the opening 400 extends generally within outer dimensions of the housing 301. Magnitudes or values of the height 410 and the width 412 of the opening 400 may be selected based on various parameters, such as variables associated with the fluid directed through the opening 400 and/or based on a component with which the sensor assembly 300 is disposed (e.g., plenum of a duct, fan inlet). For example, the height 410 and the width 412 of the opening 400 may be selected such that a fluid flow directed through the opening 400 may be representative of a fluid flow directed along the fluid flow path 308 within which the sensor assembly 300 is disposed. As noted above, the opening 400 may extend from the first surface 302 of the housing 301 to the second surface 303 of the housing 301, and thus, the depth 414 of the opening 400 may be the same as (e.g., equal is magnitude to) the depth 314 of the housing 301, such that the opening 400 extends through the depth 314 of the housing 301 along the lateral axis 340.

The sensor assembly 300 includes a sensor system 420 disposed within the opening 400. In some embodiments, the sensor system 420 may be communicatively coupled to a controller 419 (e.g., the AHU controller 230, a control system of the HVAC system 100) to enable one or more of the functions described herein. For example, the controller 419 may be a controller of the AHU 202 and/or the HVAC system 100 described above and may have similar components and/or functionalities. The sensor system 420 includes a circuit board 421 (e.g., substrate, flex board circuit, polymide circuit board) and the sensors 500 disposed on the circuit board 421. In the illustrated embodiment, the circuit board 421 extends across the opening 400 and divides the opening 400 into a first plenum 416 (e.g., upper plenum) and a second plenum 418 (e.g., lower plenum). The circuit board 421 may extend across the opening 400 in a direction along the longitudinal axis 342 and may also extend through the opening 400 in a direction along the lateral axis 340 to divide the opening 400 into the first plenum 416 and the second plenum 418. The circuit board 421 may include a first surface 422 (e.g., top surface, upper surface) and a second surface 424 (e.g., bottom surface, lower surface). The circuit board 421 may extend for a distance 430 (e.g., length) within the opening 400 from the third surface 404 to the fourth surface 405 of the housing 301 along the longitudinal axis 342 and for a distance 432 (e.g., depth, width) within the opening 400 from the first surface 302 to the second surface 303 of the housing 301 along the lateral axis 340. The distance 430 (e.g., length) of the circuit board 421 within the opening 400 may be the same as the length 412 of the opening 400, and the distance 432 (e.g., depth) of the circuit board 421 within the opening 400 may be the same as the depth 414 of the opening 400 and/or the depth 314 of the housing 301 such that the circuit board 421 extends fully or substantially fully across and through the opening 400. It should be noted that the circuit board 421 illustrated in FIG. 3 may also include additional components (e.g., features) that are disposed within the housing 301 of the sensor assembly 300, as described in greater detail below. Further, in some embodiments, the circuit board 421 may be positioned on (e.g., be mounted to, abut) a surface (e.g., first surface 402, second surface 403) of the housing 301 such that the sensor system 420 does not divide the opening 400 into multiple plenums. For example, the circuit board 421 may be positioned on the first surface 402 of the housing 301 such that an air flow directed through the opening 400 flows beneath the circuit board 421 relative to the vertical axis 344. In other embodiments, the circuit board 421 may be positioned on the second surface 403 such that an air flow directed through the opening 400 flows above the circuit board 421 relative to the vertical axis 344.

As mentioned above, the sensor system 420 may include one or more sensors 500 (e.g., thermistors) disposed on the circuit board 421 that are configured to measure one or more properties of a fluid flow (air flow, working fluid flow, cooling fluid flow) directed through the opening 400 and across the sensor system 420. The one or more sensors 500 may be disposed on the first surface 422 of the circuit board 421, the second surface 424 of the circuit board 421, or both the first surface 422 and the second surface 424 of the circuit board 421. Indeed, the present techniques discussed herein contemplate various arrangements of the one or more sensors 500. For example, depending on the implementation of the sensor assembly 300 within the AHU 202 and/or HVAC system 100 (e.g., within a fan inlet, plenum, duct) and/or an arrangement of the sensor system 420 within the opening 400, the sensor assembly 300 may employ the circuit board 421 with one or more sensors 500 disposed on the first surface 422 and one or more sensors 500 disposed on the second surface 424, one or more sensors 500 disposed on the first surface 422 without sensors 500 disposed on the second surface 424, or one or more sensors 500 disposed on the second surface 424 without sensors 500 disposed on the first surface 422.

As noted above, the sensors 500 may enable detection of one or more properties of a fluid directed along the fluid flow path 308 and across the sensor system 420. For example, in some embodiments, the sensor system 420 may be configured to enable utilization of thermal dispersion techniques to detect a flow rate or mass flow rate of fluid directed along the fluid flow path 308. In such embodiments, at least two of the sensors 500 may be configured to operate to enable calculation of a flow rate of the fluid. In particular, one sensor 500 may be configured to detect a temperature of the fluid, and another sensor 500 may be configured to output heat to the fluid to establish, maintain, and/or determine a temperature differential between the two sensors 500, as well as to detect a temperature of the fluid. One of the sensors 500 may apply heat to the fluid via power supplied to the sensor 500 (e.g., via AHU controller 230, controller 419, a control system). The temperature measurements collected by the sensors 500 and indicative of the heat applied to the fluid via one of the sensors 500 may be utilized to determine various other fluid flow properties, including flow rate, for example. It should also be noted that the sensors 500 discussed herein may be utilized to measure a number of different fluid flows and corresponding properties associated with the fluid flows. For example, in some embodiments, the fluid flow may be a working fluid (e.g., refrigerant), and the sensors 500 may employ thermal dispersion techniques to determine one or more properties of the working fluid flow (e.g., determine a flow rate). In other embodiments, thermal dispersion techniques may be utilized to measure a pressure differential and/or humidity conditions associated with one or more fluid flows directed across the sensor system 420.

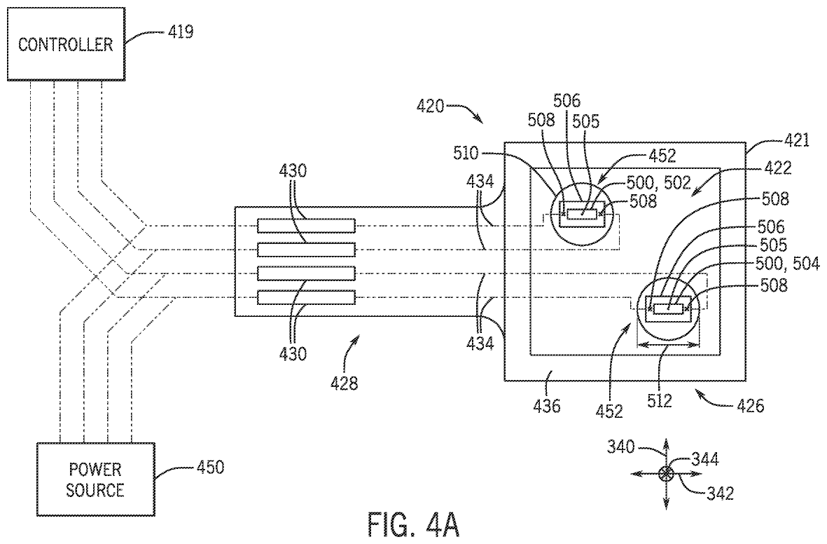

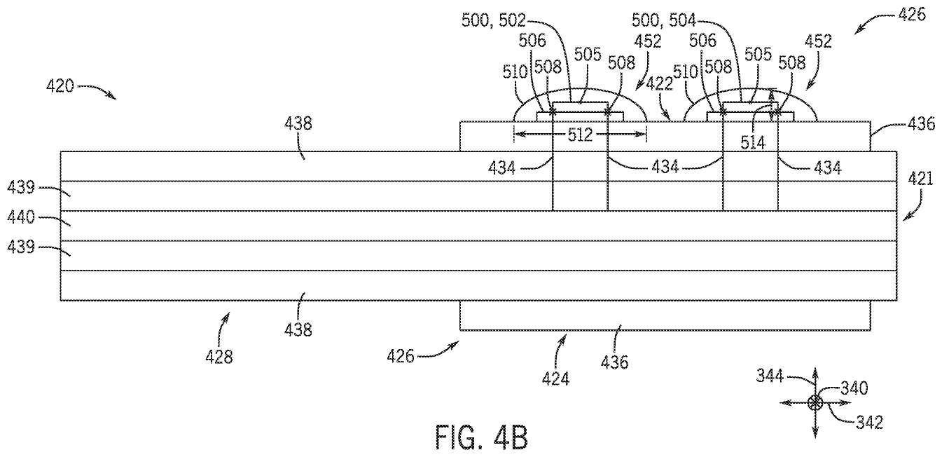

FIGS. 4A and 4B illustrate an embodiment of the sensor system 420 including the circuit board 421 (e.g., flex board circuit, polymide circuit board) with two sensors 500 (e.g., thermistors) disposed on the first surface 422 of the circuit board 421. Each sensor 500 is configured to measure one or more properties of a fluid flow (air flow, working fluid flow, cooling fluid flow) directed across the circuit board 421 (e.g., across the sensors 500, across the sensor system 420). Further, each sensor 500

As similarly discussed above, the sensor system 420 of FIGS. 4A and 4B may be associated with an embodiment of the sensor assembly 300, which may be disposed within the fluid flow path 308, such as coupled to a fan inlet and/or positioned within a duct or plenum and may be configured to measure one or more properties of a fluid flow (air flow) along the fluid flow path 308.

Turning first to FIG. 4A, a top view of an embodiment of the sensor system 420 is shown. As noted above, the circuit board 421 may include the first surface 422 (e.g., upper surface, top surface) and the second surface 424 (e.g., lower surface, bottom surface). Further, the circuit board 421 may include a sensing portion 426 (e.g., thermistor portion) and a tail portion 428 (e.g., ribbon cable tail, stem portion, extension, connection portion). The circuit board 421 may be formed from one or more materials that enable the circuit board 421 to bend and/or flex in response to a force applied. For example, the circuit board 421 may be formed from one or more layers of a polymide material, one or more adhesive layers, and one or more conductive trace layers (e.g., copper trace), as described in greater detail below. In an assembled configuration (e.g., sensor system 420 assembled with the sensor assembly 300), the sensing portion 426 of the circuit board 421 may be disposed within the opening 400 of the sensor assembly 300 (e.g., within the fluid flow path 308). The tail portion 428 may extend about a perimeter of the opening 400 (e.g., along one or more of the surfaces 402, 403, 404, 405) and be contained within the housing 301 of the sensor assembly 300. Alternatively, the tail portion 428 may extend through an aperture formed in the housing 301 (e.g., formed in one of the surfaces 402, 403, 404, 405) and be disposed external to the housing 301.

In some embodiments, the one or more sensors 500 may be arranged or positioned on the sensing portion 426 of the circuit board 421, such as on the first surface 422 of the circuit board 421. However, in other embodiments, the one or more sensors 500 may be disposed on the second surface 424, and/or one or more sensors 500 may be disposed on both the first surface 422 and the second surface 424. In some embodiments, the sensors 500 (e.g., thermistors) disposed on the circuit board 421 may be different types of sensors (e.g., relative to one another). For example, a first sensor 502 may be an ambient thermistor, and a second sensor 504 may be a heated thermistor. As noted above, the sensors 500 may be utilized to determine one or more properties of a fluid flow directed across the sensors 500 via thermal dispersion techniques. For example, the first sensor 502 (e.g., ambient thermistor) may detect a temperature of the fluid flow, and the second sensor 504 (e.g., heated thermistor) may be heated to establish or maintain a temperature differential (e.g., a set temperature differential value) between the first sensor 502 and the second sensor 504. One or more properties of the fluid flow (e.g., flow rate) directed across the sensor system 420 may be determined based on values associated with operation of the first sensor 502 and the second sensor 504 (e.g., temperature measurements collected by the sensors 500, power applied to second sensor 504, heat output by second sensor 504, and so forth).

As illustrated, the one or more sensors 500 may be disposed on the sensing portion 426, while the tail portion 428 may include one or more electrical connections 430 (e.g., contacts). Each of the electrical connections 430 may be communicatively coupled to a conductive trace 434 (e.g., copper trace), and each conductive trace 434 may extend from one of the electrical connections 430 to a respective one of the sensors 500 to provide power to the sensors 500 and/or to enable communication of data between the sensors 500 and the electrical connections 430. The electrical connections 430 may be electrically and/or communicatively coupled to a power source, a control system (e.g., controller 419, AHU controller 230), or both. In this way, power may be supplied to the sensors 500, and data collected by the sensors 500 may be transmitted to the controller 419. In some embodiments, the controller 419 may receive data from the sensors 500 and may perform operations (e.g., calculations, control operations) based on the data, such as to determine one or more properties of a fluid flow directed across the sensor system 420.

Each of the sensors 500 (e.g., ambient thermistor, heated thermistor) may be coupled to the circuit board 421 to enable transmission of power and/or data to and/or from the sensor 500. For example, each sensor 500 may be disposed (e.g., fused, soldered) on a solder pad 506 (e.g., conductive surface), and each of the solder pads 506 may be electrically coupled to the conductive trace 434. During manufacture of the circuit board 421, one or more connection points 508 may be established between the sensors 500 and the respective solder pads 506. That is, during manufacture, an electrical connection may be established between the sensors 500 and the electrical connections 430 (e.g., via the conductive traces 434) by soldering (e.g., joining) the sensors 500 to the solder pads 506 at the connection points 508. In this way, a controller (e.g., controller 419) may be communicatively coupled to the sensors 500 (e.g., via the electrical connections 430), thereby enabling communication of data received by the sensors 500 to a control system for analysis. In some embodiments, the electrical connections 430 may also be connected to a power source 450 to enable supply of power to the sensors 500 disposed on the circuit board 421.

In accordance with the present disclosure, it may be desirable to protect the one or more sensors 500 from exposure to external elements that may cause wear, degradation, or other adverse effect to the sensors 500. For example, it may be desirable to encapsulate the sensors 500 (e.g., individually) with a protective layer, material, or coating to shield each sensor 500 from contact with external elements, such as moisture, chemical compounds (e.g., carbon, salt), dust, or other matter. It may also be desirable to shield or protect the connection points 508 from exposure to external elements to protect or preserve an integrity of the electrical connections between the solder pads 506 and the sensors 500. To this end, each of the sensors 500 may be encapsulated by an encapsulation material 510 (e.g., coating material, protective layer, material cover, shroud, protective cap). Further, each of the solder pads 506 and the electrical connection points 508 may also be encapsulated by the encapsulation material 510. That is, a respective amount or quantity of encapsulation material 510 may be applied to each sensor 500 and the solder pad 506 and electrical connection point 508 associated with the sensor 500. For clarity, each sensor 500 and associated solder pad 506 and electrical connection point(s) 508 may be referred to herein as a respective sensor arrangement 452.

Each sensor arrangement 452 (e.g., sensor 500, solder pad 506, and connection point 508) may be encapsulated by a respective amount of applied encapsulation material 510. That is, the encapsulation material 510 may be locally applied to the circuit board 421. In this way, each sensor arrangement 452 may be individually encapsulated by the encapsulation material 510. Thus, an entirety of the circuit board 421 may not be layered or coated with the encapsulation material 510, thereby reducing costs associated with manufacture of the sensor assembly 300 and improving implementation of the sensor assembly 300 within the HVAC system 100 (e.g., via reduced air flow restrictions imparted by the sensor assembly 300). In some embodiments, a dimension 512 (e.g., diameter) of the encapsulation material 510 may be selected based on a size of the sensors 500 and/or the sensor arrangements 452, such that the encapsulation material 510 extends beyond (e.g., outwardly from) the sensors 500, the solder pads 506, and the connection points 508 to encapsulate electrical components and/or electrical connections associated with the sensors 500 that may otherwise be exposed to external elements (e.g., via the fluid flow directed across the sensor system 420).

The encapsulation material 510 may include a gel, such as polyurethane gel, ultraviolet curable gel, photosensitive curable gel, acrylic gel, curable gel, moisture resistant gel, insulating gel, chemical resistant gel, thixotropic gel, acrylated urethane gel, or other suitable gel. Additionally or alternatively, the encapsulation material 510 may be a paste material, conformal coating material, curable material, or other coating material. In some embodiments, the encapsulation material 510 may have a high viscosity that enables encapsulation material 510 to maintain a desired form factor after application of the encapsulation material 510 to the sensors 500 and/or sensor arrangements 452. For example, the encapsulation material 510 may have a relatively high viscosity such that upon application, the encapsulation material 510 migrates from an applied location by less than a threshold amount (e.g., less than 10 percent of the diameter 512). In some embodiments, the encapsulation material 510 may be a single component material, a high solid, photosensitive (e.g., ultraviolet [UV]) curable material that cures (e.g., hardens) when exposed to a specified spectral output. After application to the sensors 500, the encapsulation material 510 may undergo a curing process to form a tack-free (e.g., substantially tack-free) surface over the sensors 500. The encapsulation material 510 may additionally or alternatively be selected to have a desired surface hardness level (e.g., cured surface hardness), flexibility characteristic, chemical resistance, and/or moisture resistance. Further, in some embodiments, the encapsulation material 510 may fluoresce under ultraviolet light or other type of light, thereby enabling inspection of the encapsulation material 510.

Further, in some embodiments, the encapsulation material 510 may be applied to a central region 505 (e.g., a center point) of the sensor 500. In this way, a desired form factor (e.g., dome structure, half sphere geometry) of the encapsulation material 510 may be formed over the sensor 500 and the sensor arrangement 452, thereby encapsulating the sensor 500 and the solder pad 506 and connection point 508 associated with the sensor 500. By applying the encapsulation material 510 in a manner to achieve the desired form factor (e.g., dome, semi-circular, half sphere geometry), an amount of interference induced in a fluid flow directed across the sensor 500 and the encapsulation material 510 may be reduced, as described in greater detail below.

As noted above, the sensors 500 may be utilized to determine various fluid flow properties using thermal dispersion techniques. In some instances, the application of the encapsulation material 510 may affect one or more calculations performed in accordance with thermal dispersion techniques. Accordingly, in some embodiments, testing of sensors 500 and sensor arrangements 452 having the encapsulation material 510 applied thereto may be completed. In some instances, values or measurements collected by the sensors 500 may be adjusted (e.g., via an adjustment factor, application of an offset curve, formula, equation, and so forth) based on data collected and/or evaluated during testing (e.g., empirical data). For example, testing may be performed to determine operating parameters (e.g., temperature differentials, power supplied, heat transferred, temperatures detected) of the first and second sensors 502, 504 at various flow rates of fluid directed across the sensors 500 without the encapsulation material 510. After the encapsulation material 510 is applied to the sensors, additional testing may be performed. For example, additional data may be collected, such as additional values of the operating parameters discussed above, and analyzed to assess or evaluate an effect of the encapsulation material 510 on the thermal dispersion data and calculations. Based on the analysis, a suitable adjustment factor or compensation formula may be generated for application to data collected by the sensors 500 with the encapsulation material 510 in subsequent operations.

Turning to FIG. 4B, a side view of an embodiment of the sensor system 420 of FIG. 4A is shown. As noted above, the circuit board 421 of the sensor system 420 may be formed from multiple layers of material. Even so, the multiple layers of material may be configured to enable bending or flexing of the circuit board 420 (e.g., at the stem 432). In the illustrated embodiment, the circuit board 421 includes one or more outer adhesive layers 436 (e.g., adhesive layer with a removable liner) configured to enable securement (e.g., coupling, adhesion) of the circuit board 421 to a surface (e.g., surface of the sensor assembly 300, surface of the housing 301). Additionally, the circuit board 421 may include one or more polymide layers 438 configured to capture (e.g., sandwich) a conductive trace layer 440. In some embodiments, the polymide layers 438 may be coupled to the conductive trace layer 440 via one or more inner adhesive layers 439. The conductive traces 434 discussed above may extend along the conductive trace layer 440 and/or may form a portion of the conductive trace layer 440. The conductive travels 434 also extend from the conductive trace layer 440 to the solder pads 506 to enable electrical coupling between the sensors 500 and the electrical connections 430 (e.g., via the conductive traces 434 and/or the conductive trace layer 440). In some embodiments, by disposing the polymide layers 438 on opposite sides or surfaces of the conductive trace layer 440, the conductive trace layer 440 may be protected (e.g., insulated) from environmental or external elements. For example, the polymide layers 438 may be configured to limit exposure of the conductive trace layer 440 to eternal elements (e.g., moisture, particles, chemical compounds, and so forth), thereby reducing wear and degradation to the conductive trace layer 440. As a result, an encapsulation material (e.g., encapsulation material 510) may not be applied to the entire circuit board 421, thereby reducing costs associated with manufacturing the circuit board 421 and/or maintenance of the sensor system 420. It should be noted that configurations of the circuit board 421 described herein may reduce a number of electrical components that are exposed to ambient conditions and/or external elements. For example, the components of the circuit board 421 may be arranged (e.g., as described herein) so that the sensors 500, the solder pads 506, and the connection points 508 may be exposed or arranged at an outer boundary of the sensor system 420 (e.g., prior to application of the encapsulation material 510), but conductive trace layers 440 and/or conductive traces 434 are not exposed to the outer boundary of the sensor system 420 and are instead insulated from ambient conditions via the polymide layers 438. That is, each of the sensors 500 may be externally disposed on the plurality of layers.

The conductive traces 434 may extend from the conductive trace layer 440 through one or more of the inner adhesive layers 439 and through one or more of the polymide layers 438 to contact the solder pads 506. In turn, each of the sensors 500 of the sensor system 420 may be soldered to the solder pads 506 at one or more connection points 508, thereby providing an electrical connection between the conductive trace layer 440 and the sensors 500, such that data collected by the sensors 500 may be communicated to the controller 419 coupled to the electrical connections 430 via the conductive trace layer 440 (e.g., electrical signals from the sensors 500 may travel from the conductive traces 434 through the conductive trace layer 440 to the connection points 430). Similarly, power from the power source 450 may be delivered to the sensors 500 via the conductive trace layer 440, the conductive traces 434, and the solder pads 506.

The encapsulation material 510 may be deposited over the sensor arrangements 452 (e.g., sensor 500, solder pad 506, and connection point 508), thereby limiting exposure of the sensors 500, the solder pads 506, and the connection points 508 to external elements of a surrounding environment and/or a fluid flow directed across the sensor system 420. As noted above, the encapsulation material 510 may have a relatively high viscosity that enables the encapsulation material 510 to be applied with a specific form factor (e.g., shape) in an applied configuration or state. For example, the encapsulation material 510 may be applied in a dome-like structure, and the diameter 512 of each applied encapsulation material 510 may extend across the sensor 500, the solder pad 506, and the connection points 508 of a corresponding sensor arrangement 452. As shown, the diameter 512 of the encapsulation material 510 may generally extend in a direction along the lateral axis 340 and/or the longitudinal axis 342 (e.g., extending along a plane substantially parallel to the first surface 422 and/or the second surface 424 of the circuit board 421). Further, in some embodiments, the encapsulation material 510 may be applied to the circuit board 421 such that the encapsulation material 510 may extend from the circuit board 421 for a distance 514 (e.g., height) in a direction along the vertical axis 344 (e.g., away from the first surface 422). An amount of the encapsulation material 510 applied to each sensor arrangement 452 may be selected such that the distance 514 extends beyond the sensor 500, solder pad 506, and connection point 508 along the vertical axis 344, thereby causing the encapsulation material to encapsulate the sensor 500, the solder pad 506, and the connection point 508. In some embodiments, the amount of the encapsulation material 510 applied to each sensor arrangement 452 may be also selected to limit interference of the encapsulation material 510 with a fluid flow directed across the circuit board 421. Further, the form factor of the encapsulation material 510 enabled by the properties of the encapsulation material 510 may also enable reduced interference between the encapsulation material 510 and fluid flow directed across the sensor system 420. For example, the dome-like geometry of the encapsulation material 510 may enable smoother flow of the fluid across the sensors 500 and the circuit board 521. However, while the encapsulation material 510 is discussed above as having a dome-like structure when deposited over the one or more sensors 500, in other embodiments, other shapes and/or form factors may be used to encapsulate the one or more sensors 500 with the encapsulation material 510.

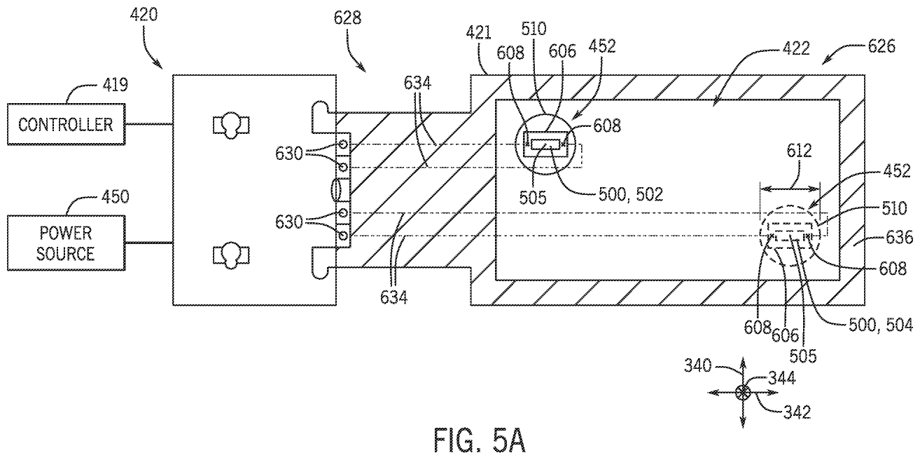

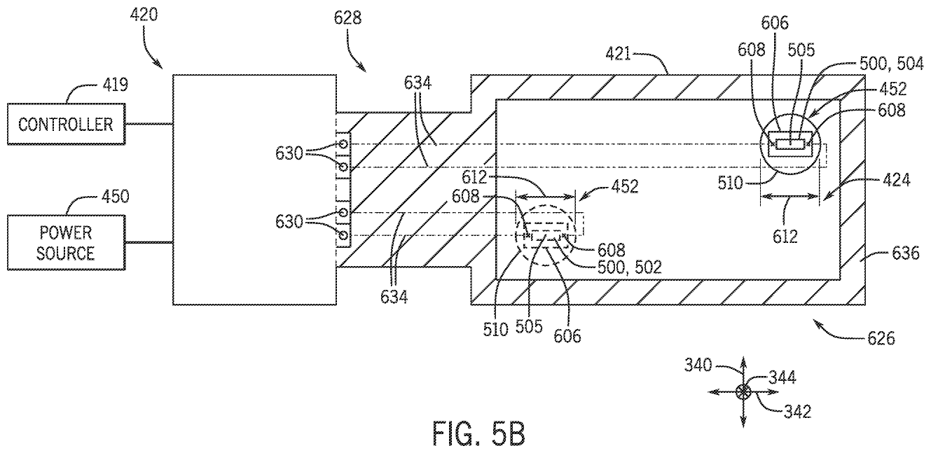

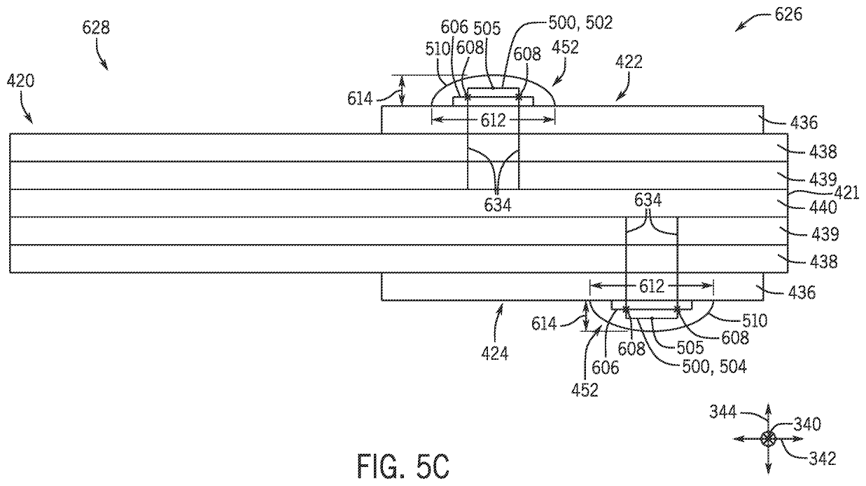

FIG. 5A-5C illustrate an embodiment of the sensor system 420 having sensors 500 disposed on the circuit board 421. In particular, the sensor system 420 includes the first sensor 502 disposed on the first surface 422 of the circuit board 421 and the second sensor 504 disposed on the second surface 424 of the circuit board 421. Each of the sensors 500 may be configured to measure one or more properties (e.g., temperature, humidity, pressure, flow rate) of a fluid flow (e.g., air flow, working fluid flow) directed across the sensor system 420 (e.g., across the circuit board 421 and the sensors 500). The sensor system 420 depicted in FIGS. 5A-5C may be a component of an embodiment of the sensor assembly 300 disposed within the fluid flow path 308, which may be defined by a plenum of a duct (e.g., ducts 112, 114, 208, 212), the inlet 284 of the fan 238, or another space configured to receive and direct a fluid flow therethrough. Thus, the sensor system 420 may be configured to measure one or more properties of an air flow directed through ductwork, the fan 238, and/or through the AHU 202.

Turning to FIG. 5A, a top view of an embodiment of the sensor system 420 is shown. As noted above, the circuit board 421 of the sensor system 420 may include the first surface 422 and the second surface 424. Further, the circuit board 421 may include a sensing portion 626 (e.g., sensor portion, thermistor portion) and a tail portion 628 (e.g., ribbon cable tail, stem portion, extension, connection portion). The circuit board 421 may be formed from one or more materials (e.g., layers of material). In some embodiments, the circuit board 421 may be configured to bend, flex, or otherwise elastically deform in response to an applied force. As discussed above, the circuit board 421 may include one or more layers of a polymide material, one or more adhesive layers, and at least one conductive trace layer. Embodiments of the circuit board 421 configured to bend or flex may be utilized in various applications or installed configurations (e.g., with the sensor assembly 300). For example, a physical configuration or positioning of the circuit board 421 with the sensor assembly 300 (e.g., housing 301) and/or within the fluid flow path 308 may be manipulated or adjusted to enable desirable exposure of the circuit board 421 and sensors 500 to a fluid flow without imparting undesired fluidic resistance to the fluid flow.

In some embodiments, the one or more sensors 500 may be arranged on or within the sensing portion 626 of the circuit board 421. As mentioned above, the illustrated embodiment includes the first sensor 502 (e.g., ambient thermistor) disposed on the first surface 422 (e.g., of the sensing portion 626) and the second sensor 504 (e.g., heated thermistor) disposed on the second surface 424 (e.g., of the sensing portion 626) of the circuit board 421. The sensors 502, 504 may be utilized to determine one or more properties (e.g., temperature, flow rate, humidity, pressure) of a fluid flow directed across the sensors 500, such as via thermal dispersion techniques. For example, during operation, the first sensor 502 may detect a temperature of the fluid flow, and the second sensor 504 may apply heat to the fluid flow. The second sensor 504 may also detect a temperature of the fluid flow and/or determine an amount of heat transferred to the fluid flow. The data collected and/or determined by the first and second sensors 502, 504 may be utilized to determine one or more properties of the fluid flow directed across the sensor system 420.

As illustrated, the sensors 500 may be disposed on the sensing portion 626, while the tail portion 628 may include one or more electrical connections 630. Each of the electrical connections 630 may be communicatively coupled (e.g., electrically coupled) to a conductive trace 634 (e.g., copper trace), and each conductive trace 634 may extend from a respective one of the electrical connections 630 to a respective solder pad 606 disposed at the sensing portion 626 of the circuit board 421. The conductive traces 634 may enable supply of power to the sensors 500 (e.g., from power source 450) and may also enable communication of data from the sensors 500 to the controller 419 (e.g., via the conductive traces 634 and the electrical connections 630), thereby enabling analysis of one or more properties of a fluid flow directed across the sensor system 420. For example, each of the sensors 500 (e.g., ambient thermistor, heated thermistor) may be disposed on one of the solder pads 606, and each of the solder pads 606 may be electrically coupled to one of the conductive traces 634. During manufacture of the sensor system 420, one or more connection points 608 may be formed between the sensors 500 and the respective solder pads 606. That is, during manufacture, an electrical connection may be established between the sensors 500 and the electrical connections 630 (e.g., via the conductive traces 634 and solder pads 606) by soldering the sensors 500 to the solder pads 606 at the connection points 608. In this way, the controller 419 or other control system may be communicatively coupled to the circuit board 421 (e.g., via the electrical connections 630), thereby enabling communication of data received by the sensors 500 to the controller 419 for analysis. In some embodiments, the electrical connections 630 and the conductive traces 634 may also provide a connection between the power source 450 and the sensors 500, thereby enabling supply of power to the sensors 500 (e.g., heated thermistor).

As noted above, in certain conditions or applications (e.g., coastal environments, lab environments, ambient environments), it may be desirable to encapsulate the sensors 500 to protect the sensors 500 from exposure to external elements (e.g., dust, chemical compounds, moisture) that may adversely affect operation and/or longevity of the sensors 500. Accordingly, each of the sensors 500 may be encapsulated by the encapsulation material 510, as discussed above. Further, each of the solder pads 606 and the electrical connection points 608 may also be encapsulated by the encapsulation material 510. In accordance with present techniques, a respective amount or portion of the encapsulation material 510 may be individually or separately applied to each sensor 500 and associated solder pad 606 and electrical connection point 608 (e.g., sensor arrangement 452). Thus, each sensor arrangement 452 may be individually encapsulated, in some embodiments, which may reduce a total amount of encapsulation material 510 utilized, may improve operation of the sensor system 420 (e.g., enable utilization of thermal dispersion techniques), and/or may reduce fluidic restrictions imposed on the fluid flow directed across the sensor system 420.

A diameter 612 (e.g., dimension) of each encapsulation material 510 applied to one of the sensor arrangements 452 may be selected based on a size of the sensors 500, a size the solder pads 606, and/or a location of the connection points 608), such that the diameter 612 of the encapsulation material 510 extends beyond the sensor 500, the solder pad 606, and the connection point(s) 608 to encapsulate the respective sensor arrangement 452. In this way, electrical components may be protected from exposure to external elements that may be present within the HVAC system 100 and/or entrained within the fluid flow directed across the sensor system 420. As noted above, the encapsulation material 510 may be a gel (e.g., polyurethane gel, urethane gel, ultraviolet curable gel, photosensitive curable gel), paste, or other material having a relatively high viscosity that enables the encapsulation material 510 to maintain a desired form factor (e.g., dome-like shape) after application of the encapsulation material 510 to the sensor arrangement 452. For example, the encapsulation material 510 may be applied to the central region 505 of each sensor 500, such that the applied encapsulation material 510 extends over the sensor arrangement 452 and forms a dome-like structure or geometry encapsulating the sensor 500, the solder pad 606, and the connection point 608 of the senor arrangement 452. The dome-like structure configuration of the applied encapsulation material 510 may enable reduced interference with a fluid flow directed across sensor system 420 (e.g., the circuit board 421 and the sensors 500).

Turning now to FIG. 5B, a bottom view of the embodiment of the sensor system 420 of FIG. 5A is shown. In the illustrated embodiment, the second sensor 504 (e.g., heated thermistor) is disposed on the second surface 424 of the circuit board 421 within the sensing portion 626 of the circuit board 421, and the first sensor 502 (e.g., ambient thermistor) is disposed on the first surface 422 of the circuit board 421 (e.g., within the sensing portion 626). Positioning the first sensor 502 on the first surface 422 of the sensing portion 626 and positioning the second sensor 504 on the second surface 424 of the sensing portion 626 may enable a reduced overall footprint of the circuit board 421, in some instances, which may thereby enable reduced interference with a fluid flow directed across the sensor system 420.

The second sensor 504 may be similarly electrically coupled to at least one of the electrical connections 630 in the manner described above with reference to FIG. 5A. The second sensor 504 and associated solder pad 606 and connection point 608 may also be similarly encapsulated with the encapsulation material 510 in the manner described above with reference to FIG. 5A. While the embodiment of FIG. 5B illustrates the diameter 612 of the first sensor 502 and the diameter 612 of the second sensor 504 as being substantially similar in size, in other embodiments, two or more of the sensors 500 may have differently sized diameters 612. Accordingly, different amounts of encapsulation material 510 may be applied to different sensors 500 (e.g., sensor arrangements 452), as discussed above.

FIG. 5C illustrates a cross-sectional side view of the embodiment of the sensor system 420 of FIG. 5A. As similarly discussed above, the circuit board 421 may be formed from multiple layers coupled to one another. For example, the circuit board 421 may include the one or more adhesive liner layers 436 (e.g., adhesive layer with a removable liner or layer) configured to enable coupling of the circuit board 421 to a surface (e.g., surface of the sensor assembly 300, housing 301). Additionally, the circuit board 421 may include the one or more polymide layers 438 capturing the conductive trace layer 440. In some embodiments, the polymide layers 438 may be coupled to the conductive trace layer 440 via the one or more inner adhesive layers 439. The polymide layers 438 capturing (e.g., sandwiching) the conductive trace layer 440 enables insulation and/or protection of the conductive trace layer 440 from external elements. Thus, an encapsulation material (e.g., encapsulation material 510) may not be applied to an entirety of the circuit board 421, thereby reducing costs associated with manufacturing the circuit board 421. It should be noted that, in some embodiments, the sensors 500 may be externally disposed on the plurality of layers (e.g., externally disposed on the adhesive liner layer 436).

As illustrated, the conductive traces 634 of the circuit board 421 may extend from the conductive trace layer 440 towards the solder pads 606 to provide an electrical connection between the sensors 500 and the electrical connections 630 (e.g., via the conductive traces 634 of the conductive trace layer 440). For example, the conductive traces 634 may extend from the conductive trace layer 440, through one or more of the inner adhesive layers 439, and through one or more of the polymide layers 438 to contact the solder pads 606. As shown, the conductive traces 634 may extend from the conductive trace layer 440 to the solder pads 606 in a direction along the vertical axis 344. However, in other embodiments, the conductive traces 634 may extend from the conductive trace layer 440 to the solder pads 606 in any suitable orientation.

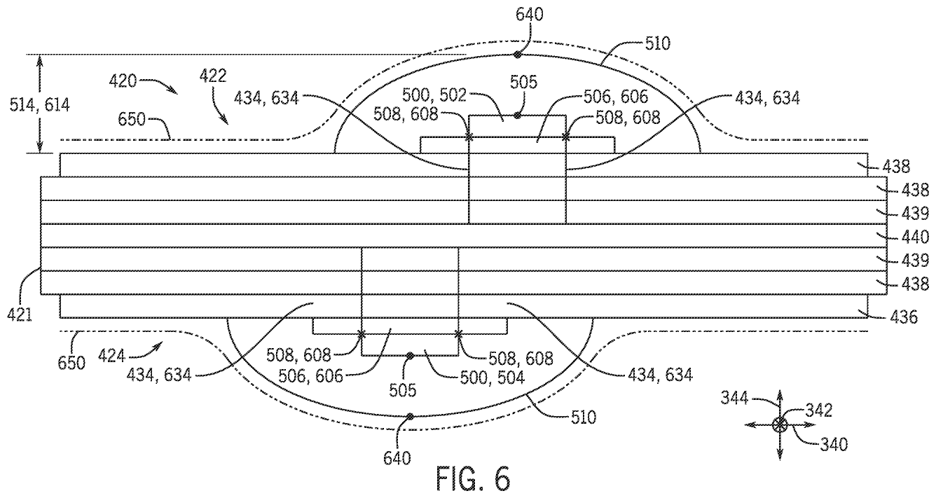

FIG. 6 is a cross-sectional side view of an embodiment of the sensor system 420, illustrating a fluid flow 650 (e.g., air flow) directed across the sensor system 420. The sensor system 420 includes similar elements and element numbers as those described above with reference to FIGS. 4A-5C. For example, the circuit board 421 of the sensor system 420 includes the first sensor 502 disposed on the first surface 422 of the circuit board 421 and the second sensor 504 disposed on the second surface 424 of the circuit board 421.

The fluid flow 650 is directed across the sensor system 420 generally along the lateral axis 340. To reduce fluidic restrictions imparted to the fluid flow 650, the circuit board 420 is also orientated along the lateral axis 340. In the illustrated orientation of the circuit board 421, the first sensor 502 and the second sensor 504 are each exposed to the fluid flow 650 as the fluid flow 650 flows across the circuit board 421. As the fluid flow 650 is directed across the circuit board 421, the encapsulation material 510 may deflect (e.g., re-direct) the fluid flow 650 to block contact between the fluid flow 650 and the sensor 500 encapsulated by the encapsulation material 510. The dome-like shape (e.g., curved geometry) of the encapsulation material 510 enables the fluid flow 650 to flow across (e.g., around) the encapsulation material 510 with reduced resistance. Further, after the fluid flow 650 travels past a central region 640 (e.g., a midpoint) of the encapsulation material 510 (e.g., relative to a direction of flow along the lateral axis 340), the fluid flow 650 may flow back towards the first surface 422 and/or the second surface 424 of the circuit board 421. Thus, the dome-like shape of the encapsulation material 510 enables a decreased amount of resistance to the fluid flow 650 directed across the circuit board 421. In this way, the fluid flow 650 directed across the circuit board 421 (e.g., across the encapsulation material 510) may be more representative of a fluid flow directed through a conduit and/or fan inlet, in which the sensor system 420 is disposed, that does not flow across (e.g., contact) the sensor system 420. As a result, data indicative of properties of the fluid flow 650 collected by the sensors 500 may be more representative of a fluid flow directed through the conduit.

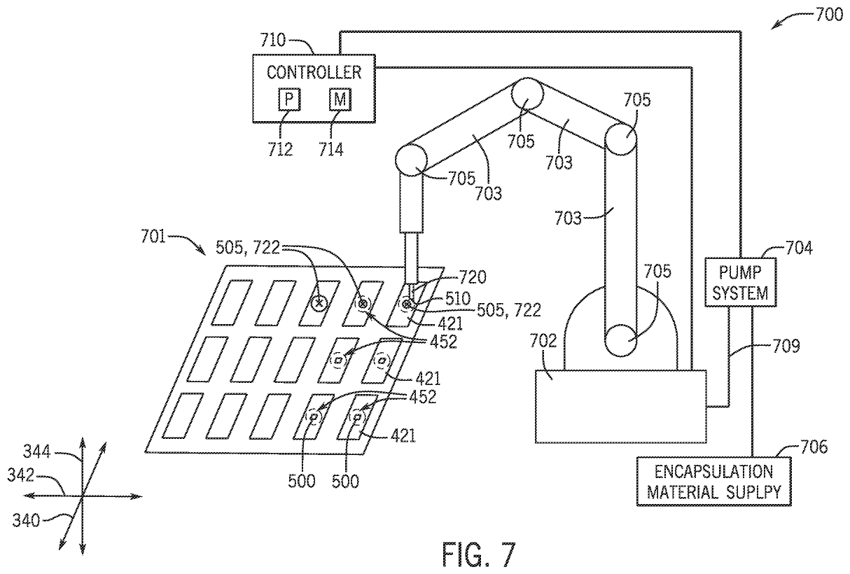

FIG. 7 is a perspective view of an embodiment of an encapsulation material dispensing system 700 (e.g., EMDS 700) configured to apply the encapsulation material 510 to a circuit sheet 701 having a plurality of the circuit boards 421 printed thereon. In the illustrated embodiment, the EMDS system 700 includes an application system 702, a pump system 704, an encapsulation material supply 706, and a controller 710. During the encapsulation of one or more sensors 500 disposed on the circuit sheet 701, the EMDS 700 may deposit the encapsulation material 510 to a specified location on the circuit sheet 701 based on coordinates received from the controller 710. For example, the application system 702 may include an applicator 720 (e.g., encapsulation material applicator, syringe, needle, deposition device) configured to discharge the encapsulation material 510 for application to one of the circuit boards 421. Accordingly, as the application system 702 receives coordinates from the controller 710 specifying a location 722 to apply the encapsulation material 510 (e.g., coordinates to deposit the encapsulation material 510 on the central region 505 of one of the sensors 500), the applicator 720 may deposit the encapsulation material 510 onto the corresponding circuit board 421 at the specified location 722.

The application system 702 may include a number of arms 703 and a number of joints 705 configured to facilitate manipulation or movement of the applicator 720 with multiple (e.g., six) degrees of freedom to facilitate desired application of the encapsulation material 510 to one or more of the circuit boards 421. Indeed, the application system 702 may move the applicator 720 with any suitable degree(s) of freedom, such as 1, 2, 3, 4, 5, or 6 degrees of freedom. Movement of the application system 702 and/or the applicator 720 may affect the characteristics (e.g., material properties) of the encapsulation material 510 deposited onto the circuit board 421. For example, decreasing a distance from the applicator 720 to the specified location 722 on the circuit board 421 may enable increased accuracy when applying the encapsulation material 510. Further, an amount of time lapsed during application of the encapsulation material 510 to the specified location 722 may be proportional to the amount of the encapsulation material 510 deposited onto the circuit board 421. For example, increasing an amount of time applying the encapsulation material 510 to the specified location 722 on the circuit board 420 may increase the amount of the encapsulation material 510 deposited onto the specified location 722.

In some embodiments, the pump system 704 may be utilized to aid the application system 702 in applying the encapsulation material 510 to the circuit boards 421. For example, the pump system 704 may be fluidly coupled to the encapsulation material supply 706 via one or more supply lines 707 (e.g., encapsulation material supply line) to provide a flow of the encapsulation material 510 to the application system 702 and through the applicator 720. The flow rate of the encapsulation material 510 through the application system 702 and the applicator 720 may affect the amount of the encapsulation material 510 deposited onto the location 722 on the circuit board 421. For example, a higher flow rate of the encapsulation material 510 will increase the amount of the encapsulation material 510 deposited onto the location 722 on the circuit board 421. The pump system 704 may include any suitable type of pump, including a gear pump, a diaphragm pump, a centrifugal pump, etc.

Further, the controller 710 (e.g., an electronic and/or processor-based controller, automation controller, control system) may be utilized to control operation of the EMDS 700. The controller 710 may independently control operation of the EMDS 700 by electrically communicating with the application system 702, the pump system 704, and/or the encapsulation material supply 706. For example, the controller 710 may control the position and movements of the arms 703 to adjust a position of the applicator 720. The controller 710 may also control operation of the applicator 720 to control discharge of the encapsulation material 510 from the applicator 720. In some embodiments, the controller 710 may control the pump system 704 to change the flow rate of the encapsulation material 510 through the applicator 720 of the application system 702. As discussed above, the encapsulation material 510 may be applied to the circuit board 421 to produce a dome-like shape or structure of the encapsulation material 510 covering the sensor arrangement 452 on the circuit board 421. For example, the controller 710 may be configured to control the position and movements of the applicator 720 of the application system 702, and/or the flow rate of the pump system 704 to deposit the encapsulation material 510 to the location 722 in a controlled manner such that a dome-like structure is formed over the sensor 500.

The controller 710 may include a distributed control system or any computer-based system that is fully or partially automated. For example, the controller 710 may include processing circuitry 712 (e.g., a microprocessor(s)) that may execute instructions (e.g., software programs, algorithms, executable code) to perform the disclosed techniques. Moreover, the processing circuitry 712 may include multiple microprocessors, one or more “general-purpose” microprocessors, one or more special-purpose microprocessors, and/or one or more application specific integrated circuits (ASICS), or some combination thereof. The controller 710 may include a memory device 714 for storing instructions executable by the processing circuitry 712. Data stored on the memory device 714 may include, but is not limited to, algorithms for operation of the application system 702, pump system 704 parameters, coordinates of the specified location 722, data related to the sensor systems 420 (e.g., dimensions of the sensors 500), and the like. The memory device 714 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). Further, the controller 710 may include multiple controllers associated with the EMDS 700 (e.g., each of the application system 702 and/or the pump system 704 may include one or more controllers).

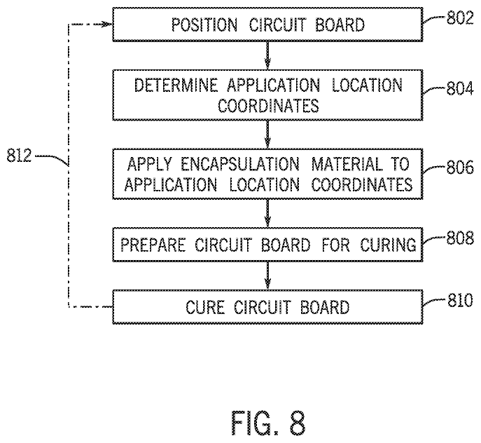

Each of the above discussed embodiments of the sensor system 420 may be at least partially produced by implementing a method that employs the EMDS 700 and/or other components (e.g., vibration table, curing system, curing lamp) to provide a plurality of sensor systems 420 having sensors 500 encapsulated with the encapsulation material 510. For example, FIG. 8 is a flow diagram of an embodiment a method 800 for applying the encapsulation material 510 to the sensor 500 on the circuit board 421. The method 800 may be performed by an automated system (e.g., one or more controllers, controller 710) and/or utilizing manual input to produce one or more circuit boards 421 having the encapsulation material 510.

At block 802, a circuit sheet 701 having a plurality of circuit boards 421 may be positioned on a surface (e.g., flat surface, horizontally oriented surface relative to gravity) to receive the encapsulation material 510 from the EMDS 700. As discussed above, the circuit boards 421 on the circuit sheet 701 may be prepared, arranged, or assembled such that the sensors 500 and associated electrical components (e.g., solder pads 506, 606, connection points 508, 608) are disposed along an outer boundary (e.g., exterior) of the circuit board 421 and are therefore exposed to ambient conditions. However, other electrical components of the circuit board 421 (e.g., conductive trace layer 440) may not be disposed along the outer boundary of the circuit board 421. For example, the polymide layers 438 of the circuit boards 421 may insulate other electrical components of the circuit board 421 (e.g., conductive traces 434, 634, conductive trace layer 440) from the ambient conditions. Thus, application of the encapsulation material 510 may be limited to the sensors 500 (e.g., sensor arrangements 452). That is, the encapsulation material 510 may not be applied to an entirety of the circuit board 421.

At block 804, the controller 710 may determine (e.g., receive) one or more coordinates (e.g., location) of the sensors 500 on the plurality of circuit boards 420 of the circuit sheet 701. The one or more coordinates correspond to the one or more locations 722 at which the applicator 720 is to apply the encapsulation material 510. For example, the controller 710 may include data stored on the memory device 714 associated with locations 722 of the sensors 500 on the circuit sheet 701 based on a type of the circuit sheet 701, a type or model of the circuit boards 421, another suitable variable, or any combination thereof. In some embodiments, an individual may manually determine the coordinates corresponding to the locations 722 at which the applicator 720 is to apply the encapsulation material 510.

Upon determining the coordinates of the sensors 500 on the circuit sheet 701, the application system 702 of the EMDS 70, at block 806, may apply the encapsulation material 510 to the sensors 500 (e.g., using the coordinates). For example, the EMDS 700 may be configured to apply a specified amount of the encapsulation material 510 and/or apply the encapsulation material 510 for a specified amount of time to each of the sensors 500 disposed on the circuit sheet 701. As noted above, the encapsulation material 510 may be deposited on each sensor 500 such that a desired form factor (e.g., dome-like shape, half sphere) is generated over each sensor 500 and the associated electrical components (e.g., solder pads 506, 606, connection points 508, 608, sensor arrangement 452). For example, in some embodiments, the controller 710 may be configured to apply the encapsulation material 510 to each sensor 500 and the associated electrical components such that the applied encapsulation material 510 has a desired diameter (e.g., diameter 512, 612) and/or a desired height (e.g., height 514, 614). In this way, a dome-like shape of the encapsulation material applied to the sensor arrangement 452 may be achieved. For example, the controller 710 may control the operation and position of the applicator 720 of the application system 702, the flow rate of the encapsulation material 510 (e.g., via the pump system 704), and/or other operating parameters of the EMDS 700 to generate a desired shape (e.g., half sphere, dome) of the encapsulation material 510 applied to the sensor 500.

After depositing the encapsulation material 510 to the circuit sheet 701 at the locations 722 corresponding to locations of the sensors 500 (e.g., central region 505), the method 800 may proceed to block 808, and the circuit sheet 701 may be prepared for a curing process. In some embodiments, preparing for the curing process may include placing the circuit sheet 701 having sensors 500 with the encapsulation material 510 on a vibration table. In some embodiments, the encapsulation material 510 may be applied to the sensors 500 with the circuit sheet 701 positioned on the vibration table. The vibration table may be configured to transition (e.g., oscillate) the circuit sheet 701 back and forth. In this way, settling of the encapsulating material 510 over, about, and/or on the sensor arrangements 452 may be achieved, such that the dome-like shape of the encapsulation material 510 is produced. That is, providing a controlled amount of movement to the circuit sheet 701 after application of the encapsulation material 510 may enable the encapsulation material 510 to settle over the sensors 500 to a desired form factor (e.g., dome-like shape). It should be appreciated that the viscosity of the encapsulation material 510 may enable resistance of the encapsulation material 510 to flow outward from the sensor arrangement 452 to beyond a desired amount during the step of block 808.

After the circuit sheet 701 is prepared for the curing process, at block 810, the circuit sheet 701 having the one or more circuit boards 420 may be exposed to a curing system to cure the encapsulation material 510, thereby securing the encapsulation material 510 to the sensors 500 and stabilizing the encapsulation material 510 in the desired dome-like shape over the sensors 500. For example, one or more ultraviolet (UV) lamps may be positioned adjacent to the circuit sheet 701 to provide UV light configured to interact with and cure the encapsulation material 510. The circuit sheet 701 having the sensors 500 with the encapsulated material 510 deposited thereon may be adjacent the UV lamp (e.g., UV light source) for a threshold amount of time (e.g., 30 second, 2 minutes) such that the encapsulation material 510 underdoes a chemical change and hardens (e.g., cures) over the sensor 500 while generally maintaining the desired form factor during the curing process. In this way, the sensors 500 (e.g., sensor arrangements 452) of the sensor system 420 exposed to an ambient environment may be insulated from external elements (e.g., chemical compounds, moisture) via the cured encapsulation materials 510.

As noted above, in some embodiments, the sensors 500 may be disposed on opposite sides of the circuit board 421 (e.g., sensors 500 disposed on both the first surface 422 and the second surface 424). Accordingly, some embodiments of the method 800 may include the step at block 812. At block 812, after performing the curing process for a first surface of the circuit sheet 701 (e.g., curing the encapsulation material 510 on the first surface 422 of each of the circuit boards 421 on the circuit sheet 701), the method 800 may be repeated to encapsulate the sensors 500 with the encapsulation material 510 on the opposite side of the circuit sheet 701 (e.g., curing the encapsulation material 510 on the second surface 424 of each of the circuit boards 421 on the circuit sheet 701). Indeed, in embodiments having sensors 500 disposed on both surfaces 422, 424 of the circuit boards 421, each of the steps of the method 800 may be performed twice to produce the circuit board 421 having sensors 500 encapsulated with the encapsulation material 510.

The systems and methods described herein for encapsulating sensors with an encapsulation material having a high viscosity enables improved performance of sensors of sensor systems that may be exposed to one or more external elements that may otherwise undesirably affect the sensors. Indeed, by encapsulating the sensors with the encapsulation material described herein, a dome-like structure may be formed over the sensors and associated electrical components to protect the sensors and electrical components from exposure to elements that may otherwise cause wear or degradation of the sensors and electrical components. In accordance with present techniques, by encapsulating the sensors with an encapsulation material that does not migrate or migrates from the applied location less than a threshold amount, the electrical components of the circuit board may be encapsulated and protected from external elements (e.g., chemical compounds, moisture) without also applying the encapsulation material to remaining portions of the circuit board that may not be susceptible to wear and degradation caused by exposure to the external elements. In this way, an amount of encapsulation material used to protect the circuit boards may be reduced, thereby reducing costs associated with the manufacture of the circuit boards. Further, by utilizing an encapsulation material that can be formed into a desired form factor (e.g., dome shape, half sphere), resistance to a fluid flow directed across the encapsulated sensors and the circuit board may be reduced, thereby improving efficiency of an HVAC system employing the circuit board having the features described herein.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A sensor assembly of a heating, ventilation, and air conditioning (HVAC) system, comprising:
a circuit board; and
a plurality of sensors disposed on the circuit board, wherein the plurality of sensors is configured to detect one or more properties of an air flow directed across the circuit board, and each sensor of the plurality of sensors is individually encapsulated by a respective amount of an encapsulation material.

2. The sensor assembly of claim 1, wherein the circuit board comprises a first surface and a second surface opposite the first surface, a first sensor of the plurality of sensors is positioned on the first surface of the circuit board, and a second sensor of the plurality of sensors is positioned on the second surface of the circuit board.

3. The sensor assembly of claim 1, wherein the circuit board comprises a plurality of layers.

4. The sensor assembly of claim 3, wherein the plurality of layers comprises a conductive trace layer captured between two polymide layers.

5. The sensor assembly of claim 4, wherein each sensor of the plurality of sensors is electrically coupled to the conductive trace layer via a respective conductive trace extending through at least one of the two polymide layers.

6. The sensor assembly of claim 1, wherein each respective amount of the encapsulation material comprises a dome shape.

7. The sensor assembly of claim 1, wherein the encapsulation material comprises a photosensitive gel, a curable gel, or both.

8. The sensor assembly of claim 1, comprising a housing defining an opening configured to receive the air flow, wherein the circuit board is disposed within the opening, and the housing is configured to be disposed within an air flow path of an HVAC system.

9. The sensor assembly of claim 1, wherein the plurality of sensors comprises a first sensor and a second sensor, the first sensor is a first thermistor configured to detect a temperature of the air flow, and the second sensor is a second thermistor configured to apply heat to the air flow.

10. The sensor assembly of claim 9, comprising a controller communicatively coupled to the circuit board and to the plurality of sensors, wherein the controller is configured to determine a flow rate of the air flow based on data received from the first sensor and the second sensor.

11. A circuit board for a sensor assembly of a heating, ventilation, and air conditioning (HVAC) system, comprising:
a plurality of layers;
a first sensor externally disposed on the plurality of layers, wherein the first sensor is encapsulated by a first amount of an encapsulation material; and
a second sensor externally disposed on the plurality of layers, wherein the second sensor is encapsulated by a second amount of the encapsulation material, wherein the first amount of the encapsulation material is separate from the second amount of the encapsulation material.

12. The circuit board of claim 11, wherein the encapsulation material comprises a photosensitive gel, a curable gel, or both.

13. The circuit board of claim 11, wherein the plurality of layers comprises a first polymide layer, a second polymide layer, and a conductive trace layer captured between the first polymide layer and the second polymide layer.

14. The circuit board of claim 13, comprising:
a first solder pad, wherein the first sensor is electrically coupled to the first solder pad;
a second solder pad, wherein the second sensor is electrically coupled to the second solder pad;
a first conductive trace extending from the first solder pad to the conductive trace layer; and
a second conductive trace extending from the second solder pad to the conductive trace layer.

15. The circuit board of claim 11, wherein the first sensor is a first thermistor configured to detect a temperature of an air flow, and the second sensor is a second thermistor configured to apply heat to the air flow.

16. The circuit board of claim 11, wherein the first sensor is disposed on a first side of the plurality of layers, and the second sensor is disposed on a second side of the plurality of layers, opposite the first side.

17. The circuit board of claim 11, wherein the first amount of the encapsulation material and the second amount of the encapsulation material each comprise a dome-shaped geometry.

18. A method of producing a circuit board having a plurality of sensors, comprising:
applying a first amount of an encapsulation material to a first sensor of the plurality of sensors to encapsulate the first sensor on the circuit board;
separately applying a second amount of the encapsulation material to a second sensor of the plurality of sensors to separately encapsulate the second sensor on the circuit board; and
curing the first amount of the encapsulation material and the second amount of the encapsulation material to adhere the first amount and the second amount to the circuit board.

19. The method of claim 18, wherein applying the first amount of the encapsulation material comprises forming a first dome-shaped geometry of the encapsulation material such that the first dome-shaped geometry covers the first sensor on the circuit board, and wherein applying the second amount of the encapsulation material comprises forming a second dome-shaped geometry of the encapsulation material such that the second dome-shaped geometry covers the second sensor on the circuit board.

20. The method of claim 18, wherein applying the first amount of the encapsulation material comprises applying a curable gel to the first sensor, and wherein applying the second amount of the encapsulation material comprises applying the curable gel to the second sensor.
